(19) United States
(12) Patent Application Publication
(10) Pub. No.: US 2009/0253593 A1
(43) Pub. Date: Oct. 8, 2009

(54) SOLID PRODUCT FOR PREPARING A DRILLING FLUID

(75) Inventors: Michel Adda, Kfar Saba (IL); Gideon Shikolsky, Kiryat Motzkin (IL); Alina Bahat, Omer (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: BROMINE COMPOUNDS LTD., Beer Sheva (IL)

(21) Appl. No.: 12/065,736

(22) PCT Filed: Sep. 14, 2006
(86) PCT No.: PCT/IL06/01083

§ 371 Date: May 26, 2009

(30) Foreign Application Priority Data
Sep. 26, 2005 (IL) 171106

(51) Int. Cl. C01F 11/34; C09K 8/05; B02C 4/32; B02C 23/08; B02C 23/18

(52) U.S. Cl. 507/145; 423/497; 241/15; 241/24.1

(57) ABSTRACT

A granulated calcium bromide product is provided, and a method for its manufacture. The product, obtained by wet granulation or by dry granulation, contains at least 80 wt. % calcium bromide, and it is particularly suitable for preparing dense calcium bromide brines used as a drilling fluid.

### FIELD OF THE INVENTION

The present invention relates to a granulated calcium bromide product having a low water content, and to a process for producing it.

### BACKGROUND

Calcium bromide solution is used as a completion, workover and drilling fluid in the oil industry, and it is currently marketed as a 52% solution. This solution is diluted during use, and a make-up of solid calcium bromide must be added to maintain a sufficient density for the drilling fluid or to increase the density of a 52% solution.

The two known forms of solid calcium bromide are powder and crystalline products (Ulmann's —Encyclopedia of Chemical Technology Fifth Edition, 1985, Wolfgand Gerhartz editor, Vol A4, page 424). Powdered calcium bromide is obtained by spray drying a brine solution containing calcium bromide salt. A purity of 95% minimum is obtained, with about 3% water. The powder obtained is very hygroscopic and consequently its dust is a health hazard causing burns to workers using it.

The crystalline product is produced by crystallization from brine. The crystal form obtained is CaBr₂.4H₂O, with a water content of 26.5%. The melting point of such a product is ˜80° C. and the liquid brine must be removed from the crystals by drying at a temperature below this, under high vacuum (below 10 mbar). In addition, such a product is not of sufficient concentration to obtain efficient enrichment of the diluted brine to be used as drilling fluid.

Another method for obtaining solid CaBr₂, containing about 73.5%, comprises steps of concentrating and flaking (IL 153232). However, the only products, currently available on the market, are powdered calcium bromide (95%) and crystallized calcium bromide product (26.5% water), having the above disadvantages. It is therefore an object of the present invention to provide a calcium bromide product in a safe, non-hazardous, form which is easier to handle by a user.

Still another object of the present invention is to provide a calcium bromide product with higher CaBr₂ content.

Still another object of the present invention is to provide calcium bromide in a non-powdered, granular, form.

Still another object of the present invention is to provide a process for producing granular calcium bromide, which is non-hazardous, contains calcium bromide in high concentration, and comprises lesser amounts of built-in water.

This and other objects of the present invention shall become clear as the description proceeds.

### SUMMARY OF THE INVENTION

The present invention provides calcium bromide product which is essentially non-powdered. Particularly, such a product is provided in a granular form, which overcomes the health-hazard risks accompanying use of a hygroscopic calcium bromide powder. Thus, the granular calcium bromide of the present invention is provided in a concentration of at least about 80 wt. %, preferably of at least about 90 wt. %, the balance being mainly water.

In one embodiment of the present invention the granular calcium bromide is provided in a concentration equal to or higher than about 80 wt. %. In another embodiment of the present invention the granular calcium bromide is provided in a concentration equal to or higher than about 90 wt. %. Preferably, the granular calcium bromide of the present invention is provided in a concentration equal to or higher than 95 wt. %, most preferably in a concentration of 98 wt. %.

According to the present invention, calcium bromide product having the above specified concentration is essentially obtained by granulation of calcium bromide powder. Therefore, the process for producing granular calcium bromide may be carried out in the following two basic granulation routes:
I. wet granulation; and
II. compaction/granulation (dry granulation).
   The basic material used for both routes for the preparation of the granular product is calcium bromide powder, preferably but not limitatively obtained by spray-drying of a brine solution.

Wet granulation as known in the art relates to a process where a powder is contacted with water to form wet granules, which are then dried. In the present invention, the term “wet granulation” refers to a process where the powder is contacted with water and the product obtained is a hydrate of that powder. According to the wet granulation process of the present invention no drying is required.

Dry granulation of calcium bromide may be carried out by compaction in a roller compactor. Spraying of water to the roller is required to permit efficient operation when such a method is used for calcium chloride (GB 1439570), since the material to be compacted immediately glues up all the depressions of the roller. It has surprisingly been found that in the case of calcium bromide, easy compaction is achieved without the need of any additives.

The invention relates to a process for the manufacture of granular calcium bromide comprising from about 80 wt. % to about 98 wt. % calcium bromide, and from about 2 wt. % to about 20 wt. % water, said process comprising i) providing a solid material consisting essentially of calcium bromide and water; ii) adjusting the particle size of said solid material so that at least a part thereof consists of particles having a size in the range of 0.1 mm to 40 mm; iii) sieving the material, and rejecting the particles outside the range of 0.1 mm to 40 mm; and optionally iv) repeating steps ii) and iii) with the rejected material; wherein said process is a wet granulation process or a dry granulation process. Said wet granulation process may comprise the steps of i) providing said solid material in the form of a calcium bromide powder; ii) introducing said powder into said agitator; iii) setting an agitator to a temperature in the range between about 20° C. and about 300° C., preferably between about 50° C. and about 150° C.; and iv) while mixing, adding a coalescing agent to said powder. Said dry granulation process may be a roller compaction process, comprising the steps of i) roller compacting and sizing calcium bromide powder by passing it between rotating rollers; ii) optionally grinding; and iii) sieving. Said dry granulation process may be a hydraulic press process, comprising applying pressure in the range of about 100 kg/cm² to about 1000 kg/cm², preferably in the range of about 400 kg/cm² to about 700 kg/cm², thereby forming calcium bromide bodies.

The following will now describe in greater detail the main features of wet and dry granulation adapted for the production of granular calcium bromide.

### I. Wet Granulation of Calcium Bromide

In the wet granulation route, calcium bromide powder, obtained, inter alia, by spray drying of calcium bromide brine, is agitated in a granulator at a temperature in the range of about 20° C. to about 300° C., preferably of about 50° C. to about 150° C., and water is sprayed on the powder to promote its granulation. It has surprisingly been found that, after the addition of water and mixing for several minutes, a dry granular product is obtained. The granular product has an average particle size in the range of about 0.1 mm to about 40 mm, and preferably of about 0.5 mm to about 5 mm. This product is free flowing and essentially free of dust. The water content of the product is between about 5 wt. % and about 25 wt. %, and preferably between about 8 wt. % and about 20 wt. %.

The equipment used for the granulation at the laboratory scale is an oblique rotating pane operated in batch mode. At the production scale, the granulation may be achieved in a cylinder operated in batch or continuous mode. A following intermediate drying stage, usually taking place in a standard granulation process after obtaining the granulated product, is not required in the wet granulation of the present invention. Although there is an intermediate stage in which the product appears to be wet, the water is absorbed into the bulk of the product. Supplementary drying is therefore not required.

A model of the granulation mechanism is presented in the following illustrative scheme (I). Two powder particles are wetted and agglomerate. The agglomerate is composed of two cores of dry product, and a liquid brine which acts as a coalescing agent. The water then diffuses into the core to provide an agglomerated solid.

In one embodiment of the present invention wet granulation may be carried out with liquid water as the coalescing agent.

In another embodiment of the present invention wet granulation may be carried out with water vapor as the coalescing agent.

In still another embodiment of the present invention wet granulation may be carried out with calcium bromide solution as the coalescing agent.

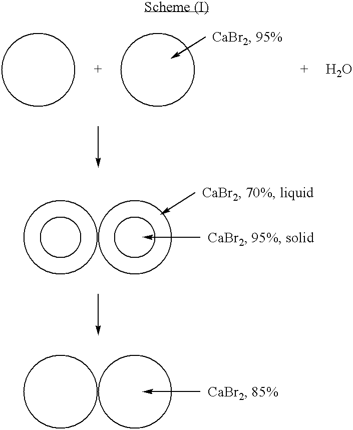

Optionally, additives such as other salts or surface active agents may be added to the liquid (water or calcium bromide brine) without deviating from the spirit of the present invention.

### II. Dry Granulation of Calcium Bromide

In the dry granulation route of the present invention, the powder is dry-granulated by means of roller compaction, optionally followed by grinding and sieving. The granules according to the present invention are binder free, with a size in the range of about 0.1 mm to about 40 mm, preferably in the range of about 0.5 mm to about 30 mm, most preferably in the range of about 2 mm to about 20 mm.

The dry granulation of the powdered calcium bromide may be accomplished using various conventional methods including but not limited to roller compaction. Roller compaction is a dry granulation process, in which powders are compacted and sized by passing them between two rotating rollers. The powder is typically roller compacted at an applied force in the range of about 1 to about 10 ton/cm, and more preferably of about 3 to about 7 ton/cm. The linear compactor roller speed is typically about 20 cm/s, and is more generally in the range of about 3 to about 50 cm/s.

In one embodiment dry compaction may be improved by recycling the output of the compactor several times.

In another embodiment dry compaction may be improved by using a screw feeder to achieve pre-compaction of the powder before its contact with the roller.

Another method for dry granulation of calcium bromide bodies is compaction in a hydraulic press. In this case, tablets of calcium bromide are prepared by applying a pressure in the range of about 100 to about 1000 kg/cm² and preferably of about 400 to about 700 kg/cm² to the calcium bromide powder.

If desired, the resulting compacted material can be ground and sieved in order to isolate the fraction of granules having the required dimensions. In order to increase the total crop of the desired fraction, granules having sizes falling outside the selected fraction can be combined with fresh calcium bromide powder and returned to the compaction device.

The final granular calcium bromide from either the wet or dry granulation can be dissolved rapidly in brine to obtain the required brine density for use as a drilling fluid.

The following Examples are intended to illustrate in a non-limiting way the procedures carried out according to the present invention and the products produced thereby.

### EXAMPLES

Examples 1-3 herein illustrate the method of producing granulated calcium bromide in wet granulation.

### Example 1

100 g of calcium bromide powder was mixed in a granulation pan. The pan had a diameter of 20 cm and a rotation speed perpendicular to the disk plane of 60 rpm. The axis of rotation was at a 30° angle to the vertical. 15 g of water was sprayed slowly into the solid. A granular product with an average particle diameter of 0.5 mm was obtained. The product was free flowing. The water content of the product was 16.9 wt. %.

### Example 2

100 g of calcium bromide powder was mixed in a granulation pan. The pan had a diameter of 20 cm and a rotation speed perpendicular to the disk plane of 60 rpm. The axis of rotation was a 30° angle to the vertical. The base below the disk was heated with a fan heater to maintain the product at a temperature of 100° C. 12 g of water was sprayed slowly into the solid. A granular product with an average particle diameter of 0.2 mm was obtained. The product was free flowing. The water content of the product was 12.9 wt. %.

### Example 3

Example 2 was repeated but with the addition of 17 g of water. A granular product with an average particle diameter of 2 mm was obtained. The water content of the product was 19 wt. %. The fraction of fines with a diameter below 0.1 mm was below 1 wt. %.

The following Examples 4-7 illustrate the dry granulation method for producing the granulated calcium bromide of the present invention.

### Example 4

3 kg of calcium bromide powder was compacted using a double-roll press (Hutt, Germany). The diameter of the roller was 22 cm, and its length was 6 cm. The compactor produced squared briquettes of 17 mm diameter and 10 mm thickness. The force applied was 4.5 ton/cm and the rotation speed 6 rpm. The material was recycled in the compactor four times in order to increase the strength of the compacted product. The product was then sieved on a 10 mm sieve. 2 kg of briquettes were obtained and 800 g of fines.

### Example 5

Example 4 was repeated but with a roller rotation speed of 14 rpm and using pre-compaction, the pre-compaction screw being operated at 50 rpm. The material was recycled three times. 2.1 kg of briquettes were obtained and 750 g of fines.

### Example 6

3 kg of calcium bromide powder was compacted using a double-roll press (Hutt, Germany). The diameter of the roller was 22 cm, and its length was 6 cm. The compactor produced pillow shaped bodies. The force applied was 4.5 ton/cm and the rotation speed was 14 rpm. Pre-compaction was applied with the pre-compaction screw operated at 40 rpm. The material was recycled twice in the compactor in order to increase the strength of the compacted product. The compacted material was then ground and sieved through a 10 mm and 2.5 mm sieve. The 2.5 to 10 mm size fraction of granules was separated (1000 g). The fines were recycled a third time and provided a second crop of 600 g after grinding and sieving. The fines were recycled a fourth time and provided a third crop of 400 g. 800 g of fines remained.

### Example 7

### Compaction with Hydraulic Press

Powdered calcium bromide was compacted using a hydraulic press. 15 g tablets were prepared in tungsten carbide cylindrical mold of 2.5 cm in diameter. The pressure applied was in the range of about 100 to about 950 kg/cm². The density of the compact was determined by measuring its volume and weight. Crushing strength was measured by standard compression test. The results are presented in the Table I below.

TABLE I

| Compaction pressure | Density | Crushing strength |
|---|---|---|
| (kg/cm²) | (g/cm³) | (kg/cm²) |
| 100 | 1.45 | 0.5 |
| 200 | 1.62 | 1.2 |
| 435 | 1.77 | 2.4 |
| 946 | 2.00 | 10.4 |

### Example 8

### Preparation of Calcium Bromide Brine from Granulated Calcium Bromide

The dissolution of the calcium bromide briquettes prepared according to Example 4 was tested. 280 g of calcium bromide aqueous brine with a density of 1.5 kg/l was contacted with 200 g of briquettes. The time required to increase the density of the brine from 1.5 to 1.7 kg/l was 15 min. and 20 min. at 25° C. and 7° C., respectively. These results indicate that the dissolution rate should not be a limiting factor in the use of the briquettes of calcium bromide.

While examples of the invention have been described for purposes of illustration, it will be apparent that many modifications, variations and adaptations can be carried out by persons skilled in the art, without exceeding the scope of the claims.

1. Granular calcium bromide product, wherein the concentration of calcium bromide in the granule is equal to or higher than about 80 wt. %.

2. Granular calcium bromide product according to claim 1, comprising from about 80 wt. % to about 98 wt. % calcium bromide, and from about 2 wt. % to about 20 wt. % water.

3. Granular calcium bromide product according to claim 1, wherein the concentration of calcium bromide in the granule is equal to or higher than about 90 wt. %.

4. Granular calcium bromide product according to claim 3, wherein the concentration of calcium bromide in the granule is equal to or higher than 95 wt. %.

5. Granular calcium bromide product according to claim 1, wherein the purity of calcium bromide on a water free basis is in the range of 95 to 98 wt. %.

6. Granular calcium bromide product according to claim 1, wherein the granule size is in the range of about 0.1 mm to about 40 mm.

7. Granular calcium bromide product according to claim 6, wherein the granule size is in the range of about 0.5 mm to about 30 mm.

8. Granular calcium bromide product according to claim 7, wherein the granule size is in the range of about 2 mm to about 20 mm.

9. Granular calcium bromide product according to claim 1, wherein the granules are obtained by wet granulation.

10. Granular calcium bromide product according to claim 1, wherein the granules are obtained by dry granulation, preferably said dry granulation is carried out by roller compaction process or hydraulic press process.

11. Granular calcium bromide product according to claim 10, wherein said dry granulation is carried out by hydraulic press process, calcium bromide bodies having a density between about 1.45 g/cm³ and about 2.00 g/cm³, and crushing strength between about 0.5 kg/cm² and about 10.4 kg/cm².

12. Granular calcium bromide product according to claim 1, wherein said granular calcium bromide is dissolved in a calcium bromide brine to rapidly increase the density of said brine for use as a drilling fluid, preferably said density is between about 1.5 kg/l and about 1.7 kg/l.

13. A process for the manufacture of granular calcium bromide comprising from about 80 wt. % to about 98 wt. % calcium bromide, and from about 2 wt. % to about 20 wt. % water, comprising
i) providing a solid material consisting essentially of calcium bromide and water;
ii) adjusting the particle size of said solid material so that at least a part thereof consists of particles having a size in the range of 0.1 mm to 40 mm;
iii) sieving the material, and rejecting the particles outside the range of 0.1 mm to 40 mm; and optionally
iv) repeating steps ii) and iii) with the rejected material;
wherein said process is a wet granulation process or a dry granulation process.

14. A wet granulation process according to claim 13, wherein said process comprises the steps of:
i) providing said solid material in the form of a calcium bromide powder;
ii) introducing said powder into said agitator;
iii) setting an agitator to a temperature in the range between about 20° C. and about 300° C., preferably between about 50° C. and about 150° C.; and
iv) while mixing, adding a coalescing agent to said powder.

15. A process according to claim 14, wherein said coalescing agent is liquid water.

16. A process according to claim 14, wherein said coalescing agent is water vapor.

17. A process according to claim 14, wherein said coalescing agent is calcium bromide brine.

18. A process according to claim 17, wherein the concentration of calcium bromide in the brine is 70 wt. %.

19. A process according to claim 14, wherein the size of the calcium bromide granules is in the range of about 0.1 mm to about 40 mm, preferably in the range of about 0.5 mm to about 5 mm.

20. A dry granulation process according to claim 13, being a roller compaction process or a hydraulic press process.

21. A roller compaction process according to claim 20 comprising the steps of:
i) roller compacting and sizing calcium bromide powder by passing it between rotating rollers;
ii) optionally grinding; and
iii) sieving.

22. A process according to claim 21, wherein the applied force in roller compacting is in the range of about 1 to about 10 ton/cm, preferably in the range of about 3 to about 7 ton/cm.

23. A process according to claim 21, wherein the size of the manufactured calcium bromide granules is in the range of about 0.1 to about 40 mm, preferably in the range of about 0.5 to about 30 mm, most preferably in the range of about 2 to about 20 mm.

24. A hydraulic press process according to claim 20 comprising applying pressure in the range of about 100 kg/cm² to about 1000 kg/cm², preferably in the range of about 400 kg/cm² to about 700 kg/cm², thereby forming calcium bromide bodies.

25. (canceled)

26. (canceled)
